(19) United States
(12) Patent Application Publication
(10) Pub. No.: US 2026/0077733 A1
(43) Pub. Date: Mar. 19, 2026

(54) ACCIDENT DETECTION

(71) Applicant: Sfara Inc., Hokoben, NJ (US)

(72) Inventor: Ali GHOMASHCHI, Brooklyn, NY (US)

(73) Assignee: Sfara Inc., Hokoben, NJ (US)

(21) Appl. No.: 19/106,427

(22) PCT Filed: Oct. 3, 2023
(86) PCT No.: PCT/US2023/075817

§ 371 Date: Feb. 25, 2025

Related U.S. Application Data
(60) Provisional application No. 63/413,047, filed on Oct. 4, 2022.

(51) Int. Cl. B60R 21/0132; G07C 5/08

(52) U.S. Cl. CPC B60R 21/0132; G07C 5/0841

(57) ABSTRACT

A method (200) for detecting and evaluating an accident of a vehicle, the method steps being carried out at least partially on a mobile device (400, 500, 600), the mobile device having at least one sensor, the mobile device being carried along with the vehicle, an accident monitoring system (307, 426, 612) being operated on the mobile device in such a manner that sensor data (101) of the sensor is continuously acquired by means of the mobile device and temporarily stored in a memory.

### CROSS-REFERENCE TO RELATED APPLICATIONS

This Application is a Section 371 National Stage Application of International Application No. PCT/US2023/075817, filed Oct. 3, 2023, and published as WO 2024/076977A1 on Apr. 11, 2024, and claims priority to U.S. Provisional Application No. 63/413,047, filed Oct. 4, 2022; the contents of each application are hereby incorporated by reference in their entirety.

### FIELD OF THE DISCLOSURE

The present disclosure generally relates to the technical field of methods for detecting and evaluating an accident of a vehicle.

### BACKGROUND

In the state of the art, methods are known in which accident detection is carried out by evaluating sensor data from a smartphone, for example, in conjunction with sensors from a motor vehicle or other available sensor data. In this context, limit values of sensor data are usually defined, which, if exceeded, allow the probability of an accident to be detected. For example, acceleration forces that do not correspond to the normal locomotion or handling of a smartphone can be detected here. However, some of the prior art methods are inaccurate and their reliability should be improved for more complex situations or less serious accidents.

### BRIEF DESCRIPTION OF THE DRAWINGS

FIG. 1 is schematic representation of acquired sensor data, in one example.

FIG. 2 is schematic representation of a process, in one example.

FIG. 3 is a block diagram showing one example of a remote server architecture.

FIG. 4 is a simplified block diagram of one example of a client device.

FIG. 5 illustrates an example of a handheld or mobile device.

FIG. 6 shows an example computer system.

### DETAILED DESCRIPTION

The technical task of one example of the present disclosure is thus to improve the state of the art and safety in road traffic.

A technical problem is solved by a method with the features described herein. Advantageous embodiments are the subject of the claims, the description and the drawings.

According to one aspect, the technical problem of the present disclosure is solved by a method for detecting and evaluating an accident of a vehicle, wherein the method steps are at least partially carried out on a mobile device, wherein the mobile device comprises at least one sensor, wherein the mobile device is carried along with the vehicle, wherein an accident monitoring system is operated on the mobile device such that
a) sensor data of the sensor is continuously acquired by means of the mobile device and temporarily stored in a memory in the manner of a loop recording memory, a loop memory, an overflow memory or a FiFo buffer memory;
b) as soon as a first threshold value defined for the sensor is passed by the sensor data, a first time stamp is set in the memory;
c) as soon as a second threshold value defined for the sensor is passed by the sensor data afterwards, a second time stamp is set in the memory;
d) as soon as the second threshold value is passed again by the sensor data afterwards, a third time stamp is set;
e) as soon as the first threshold value is passed again by the sensor data afterwards, a fourth time stamp is set,
   where the second threshold is above or below the first threshold;
f) if at least the first time stamp and the second time stamp and the fourth time stamp are present, a first characteristic of the sensor data is defined based on a time period, the time period comprising at least a portion of a time window extending between the first time stamp and the fourth time stamp;
g) the characteristic is subjected to a machine learning and evaluation process for its evaluation;
h) an accident probability is detected and/or predicted on the basis of the characteristic, as well as other already defined characteristics;
i) a result of the method is output by the mobile device.

For the purposes of the present disclosure, a loop recording memory, or a loop memory, or an overflow memory, or a FiFo buffer memory means any type of memory in which sensors continuously provide sensor data that is recorded in a memory of defined and limited size, and as soon as this memory is full, the contents recorded up to this point are overwritten with new data according to the first-in-first-out (FiFo) principle.

For the purposes of the present disclosure, the passing of a threshold value can be understood as both the exceeding and the falling below of a threshold value, depending on whether the sensor data moving towards the threshold value in their temporal sequence move towards it from below or from above the threshold value.

For the purposes of the present disclosure, a mobile device may be understood to be a cell phone, a smartphone, a tablet PC, a navigation device or the like.

A characteristic means a range of a sequence of sensor data values, which may correspond to a peak of the sensor data, for example, and may be within a certain period of time. A characteristic can also be defined by a segment of a curve of sensor data over time, wherein the segment can be assigned to a reoccurring incident in movement or behavior.

Advantageously, the method can be applied by means of a mobile device carried by a passenger or a driver, for example. Technical equipment or an additional or subsequent upgrade of the vehicle can thus be avoided. In addition, the method can be used independently of the vehicle used by the driver. It can also be used for different vehicles of a driver using the mobile device. Especially in car sharing solutions, the procedure can thus be used continuously even if the vehicle is changed. The mobile device is usually equipped with various sensors, as is the case with smartphones, for example, which means that these sensors can be used advantageously for the method.

The sensor data generated by the sensors of the mobile device while it is being carried or used can advantageously be restricted by means of the method to a characteristic that can be used to assess, evaluate, analyze or detect an accident.

By storing the sensor data in a FiFo-type memory, the sometimes limited storage capacity of a mobile device can be used to advantage. All other sensor data of the sensors that are not relevant for an accident can thus be discarded and memory space saved, which can enable the process to be carried out as quickly as possible. Advantageously, the machine learning and evaluation process can be further improved with the characteristic thus available, or for example with further characteristics from previous measurements, and thus the method. Additionally stored data is available for local processing by the computing capacity of the mobile device. This can result in lower latency than by cloud computing and can be helpful for real-time analysis.

By outputting the results of the procedure, action can advantageously be taken at the location of the mobile device to respond to the potential accident, or action can be taken to respond to potential accidents in the future, or to prevent accidents from occurring. For example, the results can be sent to a remote system, such as a call center, for initiation of a response action to the potential accident. Further, the results can be stored in the remote system, for example for use in future machine learning and evaluation processes. Alternatively, or in addition, the results can be displayed on the mobile device (e.g., on a user interface display) and/or other device(s), e.g. a mobile device of a potential accident opponent.

In a technically advantageous embodiment of the method, it is provided that the characteristic comprises the sensor data at least between the first and the fourth time stamp.

This allows the procedure to be applied in a concentrated manner to a particularly relevant part of the data, which can improve the result and a result can be achieved more quickly.

Following this advantageous embodiment, it is also possible that the characteristic comprises at least a segment of a curve of sensor data over time at least between the first and the fourth, preferably between the first and the third time stamp.

This allows the procedure to also have supplemental sensor data or multiple characteristics within the relevant time window for computing, analyzing and verification purposes.

In a further technically advantageous embodiment of the method, it is provided that a weighting is applied to the characteristic and fed to the learning and evaluation process, the weighting being based on the time stamps and/or the ratio of the time stamps to one another and/or the time differences between the time stamps and/or the course of the sensor data within the characteristic.

Weighting furthermore allows to distinguish between false positive events and reals accidents to be detected and provides another parameter for the desired method.

In another technically advantageous embodiment of the method, it is provided that the learning and evaluation process is executed locally on the mobile device and/or decentral on a cloud computing platform.

Advantageously, characteristics and/or evaluations detected, for example, by other users of other mobile devices in the same or in other vehicles, for example at a different location, for example at a different time, can be used to improve the method. In addition, computing and storage capacities remote from the mobile device can be used advantageously, which would otherwise not be available to the method.

In a further technically advantageous embodiment of the method, it is provided that the characteristic is fed to the machine learning and evaluation process only if the time span of the characteristic is less than 5 seconds, in particular less than 1 second.

This additionally allows a possible relevance of the characteristic to be better determined and the informative value of the method to be further improved.

In a further technically advantageous embodiment of the method, it is provided that following a time period of the characteristic, in particular following the fourth time stamp, a waiting time is waited for, the waiting time being up to two seconds, in particular up to one second.

The time span of the characteristic can, for example, be understood as the time between the first time stamp and the fourth time stamp. By means of the waiting time, it is possible to find out whether a run-out of the signal, a so-called Calm Ending, is detected or whether further signal deflections are detected. This can provide additional information that can further improve the process.

In a further technically advantageous embodiment of the method, it is provided that the first threshold value and/or the second threshold value is/are determined as a function of the situation, in particular variably.

For example, bumps at higher speeds provide stronger vibrations and thus larger deflections of the data, although this should not be taken into account under certain circumstances. In an advantageous way, it can thus be made possible that, for example, depending on external circumstances, such as the speed of the vehicle detected by the speed of the mobile device with respect to the environment, the threshold values can be changed and, for example, a higher or a lower threshold value is present.

In a further technically advantageous embodiment of the method, it is provided that in an initial state the functionality of the sensors is checked on the basis of the sensor data.

This can improve the reliability of the process by preventing the use of faulty sensors. FiFo Data related to a mobile device and sensors in idle mode can be analyzed and used for checking and initialization purposes.

In a further technically advantageous embodiment of the method, it is provided that sensor data are stored by means of the memory for a duration of 30 seconds, in particular for 25 seconds, preferably for 20 seconds, in particular for 15 seconds or 10 seconds.

In an advantageous way, an adequate period of time can be selected for the duration of a possible accident, in which the resulting data can be fed into the procedure. This can contribute to an improvement of the procedure, especially with regard to an accelerated execution. Preferably, the duration can also be set dynamically depending on a specific situation the mobile device is in, e.g. moved at higher speed or in a certain kind of vehicle.

In a further technically advantageous embodiment of the method, it is provided that sensor data from an audio sensor and/or an acceleration sensor and/or a photo sensor and/or a gyro sensor and/or a pressure sensor and/or a GPS sensor and/or a proximity sensor are recorded and/or evaluated.

Advantageously, the large number of sensors generally available in modern cell phones can be used for the process. For example, acoustic effects and/or changes in the acceleration of the mobile device resulting from a possible accident can be advantageously detected and processed.

In a further technically advantageous embodiment of the method, it is provided that further characteristics, defined for example by means of further mobile devices, are fed into the learning and evaluation process.

This can have an additional positive effect on improving the machine learning and evaluation process and thus the procedure and reliability, especially to avoid false positive detections.

Additionally, characteristics can be compared and parameters, e.g., for weighting or comparing can be revealed by the learning process.

In a further technically advantageous embodiment of the method, it is provided that the sensor data are subjected to a data correction, in particular depending on the situation the mobile device is in. Additional information, e.g. about the mode of transportation or a specific personal information of the person using the mobile device can be taken into account.

For example, background sensor data such as noise can thus be subtracted, which can be taken into account by means of such data correction and can have an additional beneficial effect on the method. For example, sensor data of a mobile device in free fall due to an accident can be subtracted, or the noise of a radio in the vehicle that is switched on in the background can be subtracted to additionally improve the method.

In another technically advantageous embodiment of the method, it is provided that the sensor data are corrected for the dynamics of the influence of the gravity vector on the sensor(s) of the mobile device and/or with respect to an inertial system of the mobile device.

For the purpose of the present disclosure, an inertial system means a reference frame in which every force-free body relative to this reference frame remains at rest or moves uniformly, in a straight line and not accelerated. A vector in general describes a quantity having direction as well as magnitude, especially as determining the position of one point in space relative to another.

In particular, this can have an additional beneficial effect on the procedure if the mobile device is in free fall or is flung through the vehicle as a result of a collision or accident. This can additionally improve the informative value of the data.

In another technically advantageous embodiment of the method, it is provided that the sensor data are corrected for the dynamics of the inertial movement of the vehicle with respect to the inertial system of the mobile device.

It is conceivable that in the event of an accident, the cell phone moves within the vehicle relative to the vehicle due to its inertia, which could influence or deteriorate the quality of the recorded data. Advantageously, by means of an appropriate correction of the sensor data, an improvement of the method can be made possible and the sensor data can be adapted accordingly.

In a further technically advantageous embodiment of the method, it is provided that the characteristic is compared with the further characteristics, in particular stored characteristics from the past.

This allows the advantageous use of empirical values and thus the additional improvement of the process.

In a further technically advantageous embodiment of the method, it is provided that an assessment of the characteristic is made on the basis of the sensor data between the second time stamp and the third time stamp, in particular between the first time stamp and the fourth time stamp, in particular with regard to how serious an event triggering the characteristic, in particular an accident, is.

Advantageously, the specific course of the sensor data within the characteristic can thus be taken into account, providing individual possibilities for evaluation, which can additionally improve and optimize the process for future applications.

In general it is clearly understood that the machine learning and evaluation process can take multiple characteristics into account resulting from data streams of different sensors. The more characteristics can be evaluated against each other and used for additional analysis such as verification, weighting, correction, or plausibility checking, the better is the improvement on the detection quality of the method according to the invention, especially the avoiding of false positive results.

Examples of embodiments are shown in the figures and are described in more detail below.

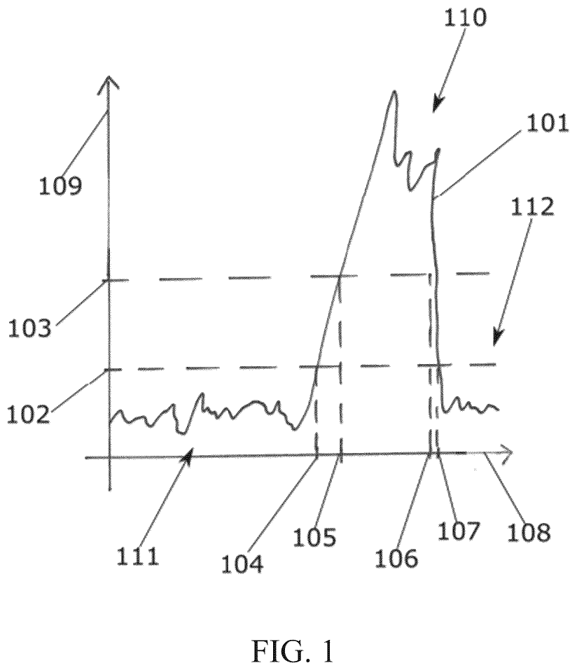

FIG. 1 shows a schematic representation of generated sensor data 101. The sensor data 101 generated by a sensor are plotted on a unit axis 109 via a time axis 108. For example, the volume of the environment of a cell phone could be plotted here as sensor data 101, with the cell phone using a microphone as a sensor to detect the sounds inside a vehicle.

The sensor data 101 are continuously acquired and temporarily stored in a memory in the manner of a loop recording memory, a loop memory, an overflow memory or a FiFo buffer memory.

Advantageously, memory space can be saved in this way and the process can be carried out more quickly, since there is a reduction in the amount of data to be processed. The temporal length of the represented sensor data 101 is up to 30 seconds, in particular 25 seconds, preferably 20 seconds, in particular 15 seconds or 10 seconds, which can additionally accelerate the execution of the method.

As soon as a first threshold 102 defined for the sensor is passed by the sensor data 101, a first timestamp 104 is set in the memory. As soon as a second threshold value 103 defined for the sensor is subsequently passed by the sensor data 101, a second time stamp 105 is set in the memory. If this second threshold value 103 is subsequently passed a further time in the reverse direction, a third time stamp 106 is set in the memory. As soon as thereafter the first threshold value is passed again by the sensor data 101, a fourth time stamp 107 is set. Hereby, an event detected by the sensors, such as an accident, can be narrowed down in time as a characteristic 110 or peak 110 in the sensor data 101. This characteristic 110 can thus be used for evaluation or analysis.

Thus, if at least three time stamps 104, 105, 106 are present, a characteristic 110 of the sensor data 101 can be defined based on a time period that lies at least between the first time stamp 104 and the fourth time stamp 106. This characteristic 110 is then fed to a machine learning and evaluation process for its evaluation, and an accident probability is predicted based on the characteristic 110.

The machine learning and evaluation process can take multiple characteristics 110 into account resulting from data streams of different sensors. The more characteristics can be evaluated against each other and used for additional analysis such as verification, weighting, correction, or plausibility checking, the better is the improvement on the detection quality of the method according to the invention, especially the avoiding of false positive results.

For example, the severity of an accident can be assessed and displayed at least on the mobile device. For example, statements can be made about how serious an accident was or what measures are to be taken in corresponding cases.

The characteristic 110 may further be applied with a weighting based on the timestamps 104, 105, 106, 107 and/or the time differences between the timestamps 104, 105, 106, 107 and/or their relationship to each other and/or the gradient of the sensor data 101 within the characteristic 110. For example, a gradient of the sensor data 101 between the first time stamp 104 and the second time stamp 105 may provide an indication of the intensity with which an impact occurred. It can also be provided that the characteristic 110 is only fed to the machine learning and evaluation process if the time span of the characteristic 110 is less than 5 seconds, in particular less than 1 second.

As shown in FIG. 1, the characteristic 110 includes sensor data 101 at least between the first timestamp and the fourth timestamp 107, and thus from a time period between the first timestamp 104 and the fourth timestamp 107.

In FIG. 1, the second threshold value 103 is shown above the first threshold value 102.

However, it is also envisaged that a case is implemented, for example the reverse and not shown in FIG. 1, in which the second threshold value 103 is below the first threshold value 102, which would be advantageous, for example, in the case of sensor data 101 from an acceleration sensor. Furthermore, the threshold values 102, 103 can be set variably and depending on the situation. This can advantageously take into account, for example, the situation when driving over a rough road, sudden jerks and/or loud noises occur abruptly, but do not imply an accident.

Furthermore, FIG. 1 shows an initial state 111 in which the functionality of the sensors can be checked using the sensor data 101. Also, for example, noise occurring in this area can be used to correct the sensor data, which can additionally improve the process. Advantageously, it may also be provided that a waiting time 112 is waited for following the time period of the characteristic, for example between the first time stamp 104 and the fourth time stamp 107. The waiting time 112 can be up to two seconds, in particular one second. Here, it can be advantageously checked whether the sensor data provide further information that can be used for evaluation. For example, a level noise in the waiting time 110, which corresponds to the noise of the initial state, may indicate a less serious accident than if the sensor data 101 would show a leakage or a zero line.

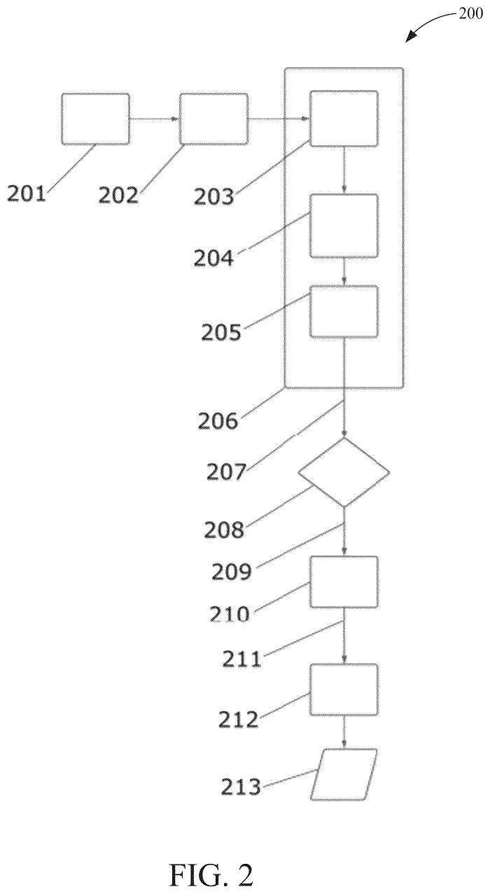

FIG. 2 shows a method 200 in conjunction with FIG. 1 that a filtering 201 of the measured variables arriving at the sensors takes place first. For example, any noise, gravity or errors are subtracted from the sensor data generated by the sensors. Advantageously, the quality of the data output by the sensor can thus be significantly increased and the process improved.

The filtered data is then stored in a memory, a data buffer 202. This operates, for example, in the manner of a FiFo buffer with a recording duration of 15 seconds. In this way, sensor data can be retained and supplied for further processing while saving on memory requirements. For example, the sensor data that is stored first is the sensor data that is discarded and deleted first after the 15 seconds, for example, have elapsed.

Within a signal processing 206 it is then checked in an initial state 203 whether, for example, the sensor data correspond to initial conditions. For example, it is checked here whether the sensors used are fully functional and whether, for example, an acceleration sensor outputs no or only low values as expected before the start of the journey. Advantageously, this prevents the procedure from being carried out with faulty sensor data.

A second threshold value 204 then specifies the condition that the sensor data correspond to conditions of a threshold value. For example, a defined volume value or a defined acceleration value can be specified here, which must be exceeded in order to be able to progress further in the process. Such a threshold value can be variable and depend on further parameters or external circumstances. For example, it can be changed depending on the travel speed in a vehicle.

In a final state 205, a check is made to see if the data meets the conditions of a final state. For example, following a strong acceleration due to an accident, only a very slight acceleration or an absence of sensor data would be expected.

Once the signal processing 206 has determined the time frame for the start and end time and thus the time span of a characteristic 110 of a possible accident shown in FIG. 1, a transfer 207 of the data collected between the start and end time takes place as characteristic 110 to a next step.

In a check of the characteristic 208 that now takes place, for example, its duration, speed, gradient or intensity are compared with previously defined conditions. Advantageously, a possibly incorrectly defined characteristic 110 can be withheld from further processing, which can additionally improve the quality of the process.

However, if the characteristic 110 corresponds to the previously defined conditions and this case can be affirmed 209, an extraction 210 of the characteristic 110 takes place and a transfer 211 of the characteristic 110 into a machine learning and evaluation process 212 follows. Here, the characteristic 110 can be advantageously analyzed and statements can be made about it. This can take place locally in the mobile device or remotely, for example by means of cloud computing.

Subsequently, for example, a prediction probability about the alleged accident can be determined or an evaluation can take place.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In one example, these can include computer processors with associated memory and timing circuitry, not separately shown. They are functional parts of the systems or devices to which they belong and are activated by, and facilitate the functionality of the other components or items in those systems. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

Also, user interface display(s) have been discussed. Examples of user interface displays can take a wide variety of forms with different user actuatable input mechanisms. For instance, a user input mechanism can include icons, links, menus, text boxes, check boxes, etc., and can be actuated in a wide variety of different ways. Examples of input devices for actuating the input mechanisms include, but are not limited to, hardware devices (e.g., point and click devices, hardware buttons, switches, a joystick or keyboard, thumb switches or thumb pads, etc.) and virtual devices (e.g., virtual keyboards or other virtual actuators). For instance, a user actuatable input mechanism can be actuated using a touch gesture on a touch sensitive screen. In another example, a user actuatable input mechanism can be actuated using a speech command.

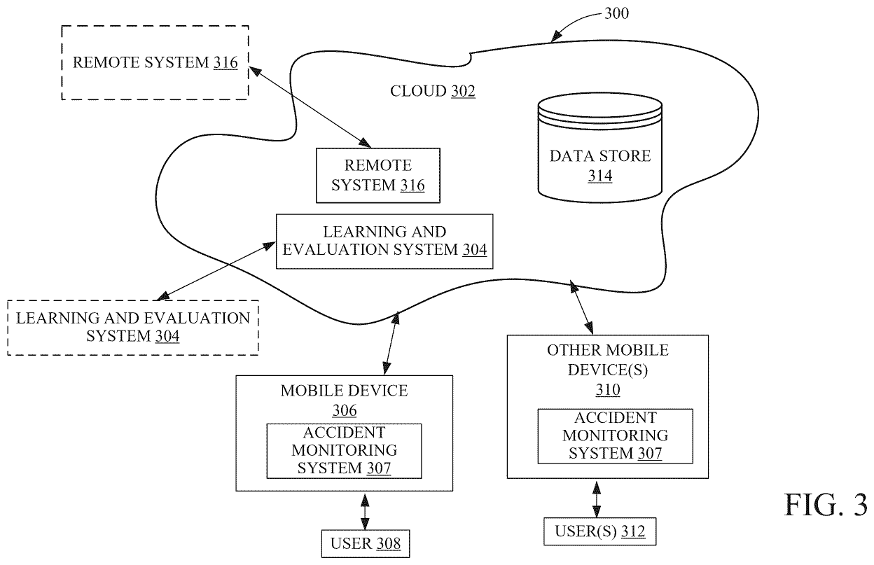

FIG. 3 is a block diagram of one example of a remote server architecture 300. In an example, remote server architecture 10 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component.

FIG. 3 shows that the learning and evaluation system can be located at a remote server location 302, as represented by block 304. Therefore, the mobile device (e.g., mobile device 306) of the user (e.g., user 308) accesses system 304 through remote server location 302. Further, mobile device(s) 310 of other users 312 can also access system 304. Each of mobile devices 306 and 308 can include an accident monitoring system 307, as indicated in FIG. 3. Examples of an accident monitory system are discussed above. Remote server location 302 can also include a data store 314 and a remote system 316. Examples of remote system 316 are discussed above.

FIG. 3 also depicts another example of a remote server architecture. FIG. 2 shows that it is also contemplated that some elements are disposed at remote server location 302 while others are not. Regardless of where they are located, the elements can be accessed directly by mobile devices 306, 310, through a network (either a wide area network or a local area network). The elements can be hosted at a remote site by a service, or they can be provided as a service, or accessed by a connection service that resides in a remote location.

The elements of the described figures, or portions of the elements, can be disposed on a wide variety of different devices. Some of those devices include servers, desktop computers, laptop computers, tablet computers, or other mobile devices, such as palm top computers, cell phones, smart phones, multimedia players, personal digital assistants, etc.

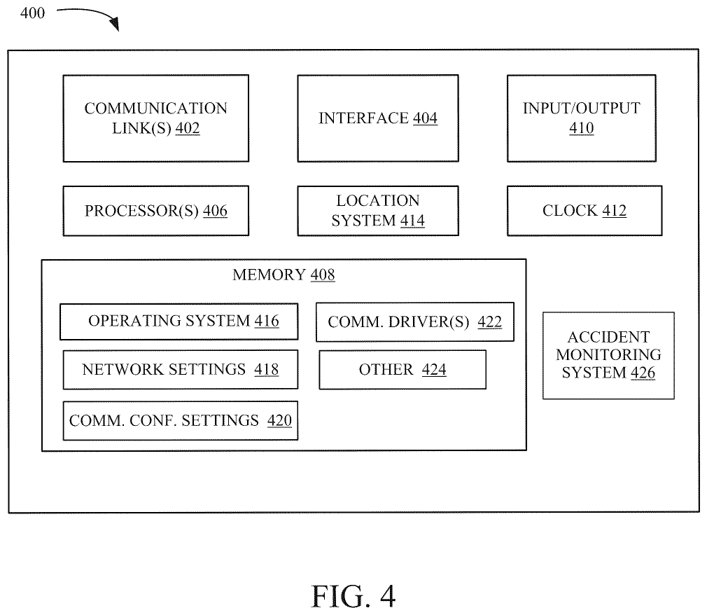

FIG. 4 is a simplified block diagram of one example of a client device 400, such as a handheld or mobile device, in which the present system (or parts of the present system) can be deployed.

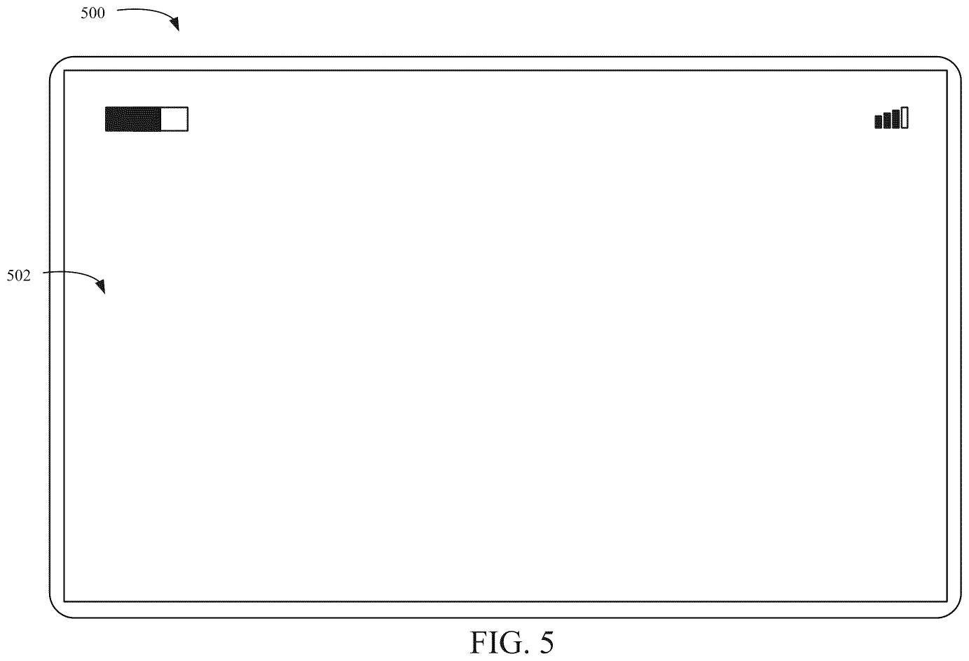

FIG. 5 illustrates an example of a handheld or mobile device.

One or more communication links 402 allows device 400 to communicate with other computing devices. An example includes communication protocols, such as wireless services used to provide cellular access to a network, as well as protocols that provide local wireless connections to networks. Applications or other data can be received on an external (e.g., removable) storage device or memory that is connected to an interface 404. Interface 404 and communication links 402 communicate with one or more processors 406 along a communication bus, that can also be connected to memory 408 and input/output (I/O) components 410, as well as clock 412 and a location system 414.

Components 410 facilitate input and output operations for device 400, and can include input components such as microphones, touch screens, buttons, touch sensors, optical sensors, proximity sensors, orientation sensors, accelerometers. Components 410 can include output components such as a display device, a speaker, and or a printer port.

Clock 412 includes, in one example, a real time clock component that outputs a time and date, and can provide timing functions for processor 406. Location system 414 outputs a current geographic location of device 400 and can include a global positioning system (GPS) receiver, a LORAN system, a dead reckoning system, a cellular triangulation system, or other positioning system. Memory 408 stores an operating system 416, network applications and corresponding configuration settings 418, communication configuration settings 420, communication drivers 422, and can include other items 424. Examples of memory 408 include types of tangible volatile and non-volatile computer-readable memory devices. Memory 408 can also include computer storage media that stores computer readable instructions that, when executed by processor 406, cause the processor to perform computer-implemented steps or functions according to the instructions. Processor 406 can be activated by other components to facilitate functionality of those components as well. Device 400 also includes an accident monitory system 426.

FIG. 5 illustrates one example of a tablet computer 500 having a display screen 502, such as a touch screen or a stylus or pen-enabled interface. Screen 502 can also provide a virtual keyboard and/or can be attached to a keyboard or other user input device through a mechanism, such as a wired or wireless link. Alternatively, or in addition, computer 500 can receive voice inputs.

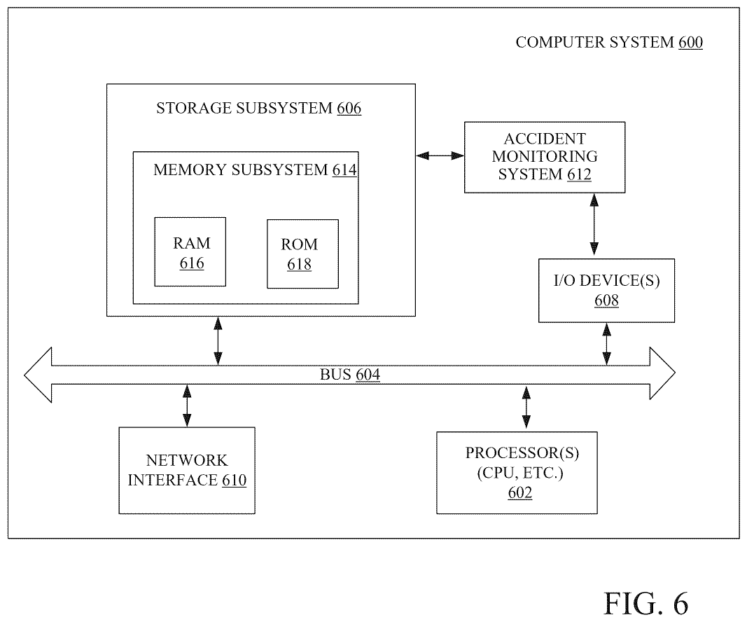

FIG. 6 shows an example computer system 600 that can be used to implement the described technology. Computer system 600 includes at least one processor 602 (e.g., central processing unit (CPU)) that communicates with a number of peripheral devices via bus subsystem 604.

These peripheral devices can include a storage subsystem 606 including, for example, memory devices, user interface input and/or output devices 608, and a network interface 610. Devices 608 allow user interaction with computer system 600. Network interface subsystem 610 provides an interface to outside networks, including an interface to corresponding interface devices in other computer systems. In one example, an accident monitoring system 612 is communicably linked to storage subsystem 606 and devices 608. Devices 608 can include keyboards, pointing devices (e.g., a mouse, trackball, touchpad, or graphics tablet), a scanner, a touch screen, audio input devices (e.g., voice recognition systems and microphones), and/or other types of devices.

Devices 608 can also include devices such as printers, a fax machines, non-visual displays, visual displays (e.g., LED displays, cathode ray tubes (CRT), flat-panel devices, or some other mechanism for creating a visible image.

Storage subsystem 606 stores programming and data constructs that provide the functionality of some or all of the modules and methods described herein. These software modules are generally executed by processors 602. Processors 602 can also include graphics processing units (GPUs), field-programmable gate arrays (FPGAs), application-specific integrated circuits (ASICs), and/or coarse-grained reconfigurable architectures (CGRAs). Processors 678 can be hosted by a deep learning cloud platform such as Google Cloud Platform™, Xilinx™, and Cirrascale™. Examples of processors include Google's Tensor Processing Unit (TPU)™, rackmount solutions like GX4 Rackmount Series™, GX6 Rackmount Series™, NVIDIA DGX-1™, Microsoft′ Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

A memory subsystem 614 used in the storage subsystem 606 can include a number of memories including a main random access memory (RAM) 616 for storage of instructions and data during program execution and a read only memory (ROM) 618 in which fixed instructions are stored.

Bus subsystem 604 provides a mechanism for letting the various components and subsystems of computer system 600 communicate with each other as intended. Although bus subsystem 604 is shown schematically as a single bus, alternative implementations of the bus subsystem can use multiple busses.

Computer system 600 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 600 depicted in FIG. 6 is intended only as a specific example for purposes of illustrating the preferred implementations of the present invention. Many other configurations of computer system 600 are possible having more or less components than the computer system depicted in FIG. 6.

Although the present invention has been described with reference to embodiments, workers skilled in the art will recognize that changes may be made in form and detail without departing from the spirit and scope of the invention.

### List of Reference Signs

101 Sensor data
102 first threshold
103 second threshold
104 first time stamp
105 second timestamp
106 Third timestamp
107 fourth timestamp
108 Time
109 Unit
110 Characteristic/Peak
111 initial state
112 Waiting time
201 Filtering
202 Data buffer
203 Initial state
204 second threshold
205 Deep final state
206 Signal processing
207 Transfer of the characteristic
208 Checking the characteristic
209 Yes
210 Extraction of the characteristic
211 Transfer of the characteristic
212 machine learning and evaluation process
213 Prediction probability

1. A method for detecting and evaluating an accident of a vehicle,
wherein the method is at least partially performed on a mobile device,
wherein the mobile device comprises at least one sensor,
with the mobile device being carried along with the vehicle, and
wherein an accident monitoring system is operated on the mobile device the method comprising:
continuously acquiring, by the mobile device, sensor data of the at least one sensor and temporarily storing the sensor data in a memory comprising at least one of a loop recording memory, a loop memory, an overflow memory, or a FiFo buffer memory;
setting a first time stamp in the memory in response to the sensor data passing a first threshold value defined for the at least one sensor;
setting a second time stamp in the memory in response to the sensor data passing a second threshold value defined for the sensor thereafter;
setting a third time stamp in response to the sensor data passing the second threshold value again thereafter;
setting a fourth time stamp in response to the sensor data passing the first threshold value again thereafter, wherein the second threshold value is above or below the first threshold value;
if at least the first time stamp and the second time stamp and the fourth time stamp are present, defining a first characteristic of the sensor data based on a time period, the time period comprising at least a portion of a time window extending between the first time stamp and the fourth time stamp;
feeding the characteristic to a machine learning and evaluation process for its evaluation of the characteristic;
detecting and/or predicting an accident probability based on the characteristic and at least one predefined characteristic; and
outputting, by the mobile device, a result based on the accident probability.

2. The method according to claim 1, wherein the characteristic comprises the sensor data at least between the first time stamp and the fourth time stamp.

3. The method according to claim 1, wherein a weighting is applied to the characteristic and is fed to the learning and evaluation process, wherein the weighting is based on the time stamps and/or a ratio of the time stamps to each other and/or the time differences between the time stamps and/or a history of the sensor data within the characteristic.

4. The method according to claim 1, wherein the learning and evaluation process is executed locally on the mobile device and/or decentrally on a cloud computing platform.

5. The method according to claim 1, wherein the characteristic is fed to the machine learning and evaluation process only if the time span of the characteristic is less than 5 seconds.

6. The method according to claim 1, wherein a waiting time is waited for following a time period of the characteristic, the waiting time being up to two seconds.

7. The method according to claim 1, wherein the first threshold value and/or the second threshold value is/are determined as a function of an operational characteristic of the mobile device.

8. The method according to claim 1, and further comprising checking, in an initial state, the functionality of the at least one sensor using the sensor data.

9. The method according to claim 1, wherein the sensor data is stored for a duration of at least 30 seconds.

10. The method according to claim 1, and further comprising detecting and/or evaluating sensor data of an audio sensor and/or an acceleration sensor and/or a photo sensor and/or a gyro sensor and/or a GPS sensor and/or a proximity sensor.

11. The method according to claim 1, and further comprising feeding further characteristics of further mobile devices into the learning and evaluation process.

12. The method according to claim 1, wherein the sensor data are subjected to a data correction.

13. The method according to claim 1, wherein the sensor data are corrected for the influence of the gravity vector on the at least one sensor of the mobile device and/or with respect to an inertial system of the mobile device.

14. The method according to claim 1, wherein the sensor data are corrected for the dynamics of the inertial system of the vehicle with respect to the inertial system of the mobile device.

15. The method according to claim 11, wherein the characteristic is compared with the further characteristics.

16. The method according to claim 1, wherein an assessment of the characteristic is made on the basis of the sensor data between the second time stamp and the third time stamp.

17. The method according to claim 1, wherein the result of the method is displayed at least on the mobile device.

18. The method according to claim 1 wherein the machine learning and evaluation process takes multiple characteristics into account resulting from data of different sensors.

19. The method according to claim 18, wherein the machine learning and evaluation process takes the multiple characteristics into account for additional analysis including one or more of verification, weighting, correction, or plausibility checking of the accident probability.

20. A accident monitoring system comprising:
at least one processor; and
instructions executable by the at least one processor, wherein the instructions, when executed, cause the accident monitoring system to:
continuously acquire sensor data of the at least one sensor and temporarily storing the sensor data in a memory comprising at least one of a loop recording memory, a loop memory, an overflow memory, or a FiFo buffer memory;
set a first time stamp in the memory in response to the sensor data passing a first threshold value defined for the at least one sensor;
set a second time stamp in the memory in response to the sensor data passing a second threshold value after the sensor data past the first threshold value;
set a third time stamp in response to the sensor data passing the second threshold value again;
set a fourth time stamp in response to the sensor data passing the first threshold value again, wherein the second threshold value is above or below the first threshold value;
based on presence of at least the first time stamp, the second time stamp, and the fourth time stamp, define a first characteristic of the sensor data based on a time period, the time period comprising at least a portion of a time window extending between the first time stamp and the fourth time stamp;
feed the characteristic to a machine learning and evaluation process;
detect and/or predict an accident probability based on the characteristic and at least one predefined characteristic; and
output, by the mobile device, a result based on the accident probability.
